(19) United States
(12) Patent Application Publication
(10) Pub. No.: US 2019/0080405 A1
(43) Pub. Date: Mar. 14, 2019

(54) SYSTEM AND METHOD OF PROVIDING A REMEDIATION TO TOKEN OFFERINGS

(71) Applicant: TEMPLUM, INC., New York, NY (US)

(72) Inventors: Vincent MOLINARI, Laurel Hollow, NY (US); Christopher PALLOTTA, New York, NY (US)

(21) Appl. No.: 16/126,929

(22) Filed: Sep. 10, 2018

Related U.S. Application Data
(63) Continuation of application No. 15/958,801, filed on Apr. 20, 2018.
(60) Provisional application No. 62/556,568, filed on Sep. 11, 2017.
(60) Provisional application No. 62/560,267, filed on Sep. 19, 2017.

(51) Int. Cl. G06Q 40/04; G06Q 20/06; H04L 9/06; G06Q 20/22; G06Q 40/02; G06Q 40/06

(52) U.S. Cl. CPC G06Q 40/04; G06Q 20/06; H04L 9/0637; G06Q 20/223; H04L 2209/38; G06Q 40/02; G06Q 40/06

(57) ABSTRACT

A method is provided for performing a remediation process for tokens initiated an initial coin offering that were illegal or unregulated. The method includes receiving a confirmation that the issuer of tokens in the initial coin offering acted in good faith, and initiating a smart contract to manage the extinguishment of the tokens from the initial coin offering and issuing new remediated tokens to comply with regulatory requirements. The smart contract can be programmed to communicate information and receive instructions from buyers of tokens from the initial coin offering, such that an offer of rescission can be contemplated and selections can be made by the buyer for initiating the remediation process for tokens that they desire to trade on an authorized exchange. The smart contract that manages the remediation process to generate the new remediated tokens.

### PRIORITY

This application is a continuation of U.S. application Ser. No. 15/958,801, filed Apr. 20, 2018, which claims priority to U.S. Provisional Application No. 62/556,568, filed Sep. 11, 2017, the contents of each of which are herein incorporated by reference in their entireties. This application claims priority to U.S. Provisional Application No. 62/560,267, filed Sep. 19, 2017, the content of which is herein incorporated by reference in its entirety.

### RELATED APPLICATIONS

The present application is related to Applications have Docket Nos. 155-0002-NP, 155-0004-NP and 155-0005-NP, filed on the same day as the present application. Each of these applications is incorporated herein by reference.

### TECHNICAL FIELD

The present disclosure relates to a remediation approach to tokens issued improperly in initial coin offerings with respect to the tokens being deemed securities. This disclosure introduces a remedial approach that technically corrects for improperly issued tokens.

### BACKGROUND

In the rapid evolution of the acceptance of initial coin offerings (ICOs) and tokenized product offerings, or any other digital asset offerings, there currently exists significant confusion about, lack of understanding of, and disregard for the manner in which monies are aggregated into tokens, and what a token actually represents. The way tokens are generated electronically and sold or offered to buyers, and the associated confusion about what they are and represent illustrates a technical problem with respect to ICOs, how tokens are offered and how they are issued and used on a computer network.

An ICO is an unregulated means of crowdfunding via use of cryptocurrency. The term is often confused with tem “token sale” or “crowdsale”, which refers to a method of selling participation in an economy, giving investors access to the features of a particular project starting at a later date. ICOs, on the other hand, sell a right of ownership or royalties to a project. The “coin” in an ICO is a symbol or a token of ownership interest in an enterprise. It is like a digital stock certificate. In contrast to initial public offerings (IPOs), where investors gain shares in the ownership of the company, for ICOs, the investors buy coins of the company, which can appreciate in value if the business is successful.

Tokens typically take the form of a utility or special purpose token to be utilized within the ecosystem of the issuer. However, in many cases, tokens including a profit participation or revenue share determined by the token issuer are actually securities when the Howey test is applied to the tokens.

The success of ICOs has become a favorite subject of the global media due to the rapid time in which capital is aggregated and also the sheer size of token sales, which may eclipse hundreds of millions of dollars in a single issuance within weeks. This has led to tokens being misused and investors misconstruing what the tokens actually represent. Many companies issued tokens via ICOs innocently thinking that they did not need to comply with security regulations.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example system configuration;

FIG. 2 illustrates various components in the platform;

FIG. 3 illustrates a blockchain network;

FIG. 4 illustrates a method embodiment; and

FIG. 5 illustrates another method embodiment;

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. There is a significant need for a framework which facilitates clear issuance of tokens as securities and in compliance with regulatory law and which has a technical component related to how tokens are issued and sold.

### Overview

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The present disclosure shall introduce a remedial approach, which can be offered to companies and individuals who participated in an initial coin offering or the like, in which the tokens issued did not comply with security regulations. In many instances, the process of issuing tokens outside of the security regulations was performed innocently. There are number of different cryptocurrency trading platforms upon which tokens or crypocurrencies can be traded, but which are not regulated according to the securities regulations or an appropriately registered alternative trading system or exchange. However, once tokens or crypocurrencies trading on these platforms are deemed to be securities, they can no longer be traded because the trading platforms are not appropriately registered and authorized to trade securities.

SEC Chairman Jay Clayton issued a report in Jul. 25, 2017 which cautioned market participants that offers and sales of digital assets by distributed autonomous organizations (DAOs) are subject to the requirements of the federal securities laws. The report explained that such offers and sales, conducted by organizations using distributive ledger or blockchain technology, have been referred to as initial coin offerings or token sales. The report found that token offerings by a DAO were securities in many instances, and therefore subject to federal securities laws. The report confirmed that issuers of digital assets via a distributive ledger or blockchain technology must register offers and sales of such securities unless a valid exemption applies. The question of whether such digital assets were securities has been discussed for a number of years and, in many cases, companies offered the sale of digital assets believed that they were not subject to federal securities laws.

Tokens that should be securities, but are not, need to be delisted from crypto currency exchanges. Not being securities, such tokens also cannot be traded on a registered or defined exchange that complies with federal security laws. Fundamentally, such tokens cannot be traded on an approved exchange because they were not issued to the buyers or token holders as securities. Therefore, the fundamental problem can be identified. A certain value associated with these tokens exists, but there is no platform upon which they can be traded. In some situations, trading of such tokens or crypocurrencies may illegally occur.

The present disclosure introduces a technical solution which can provide a pathway to enable tokens which were originally issued not as a security and which have been delisted from a trading platform to be converted to a security. The investors in this scenario are trapped with what could be called orphan tokens that do have some inherent value but where there is no avenue that can enable a trading platform for trading such tokens. This present disclosure provides the public good of salvaging the investment of individuals who bought such tokens, and providing a potential pathway to liquidity.

The basic methodology disclosed herein involves several components. First, an interface is provided for issuers of tokens to register with a platform in which they acknowledge that they issued inappropriate tokens and must take certain steps to remedy the fact that the tokens they issued were or should have been considered as securities. The issuer must offer the purchasers of such tokens are right of rescission where investors can receive their money back or if they determine to maintain or to keep their investment, a separate process can occur which will extinguish the original token and reissue the token as a security under an appropriate regulatory structure, such as Reg D or Reg A. A smart contract built upon blockchain technology can manage and perform at least some of the functions of the remedial process. A platform will provide the appropriate communications, via a user interface between the platform and purchasers of the tokens.

### DETAILED DESCRIPTION

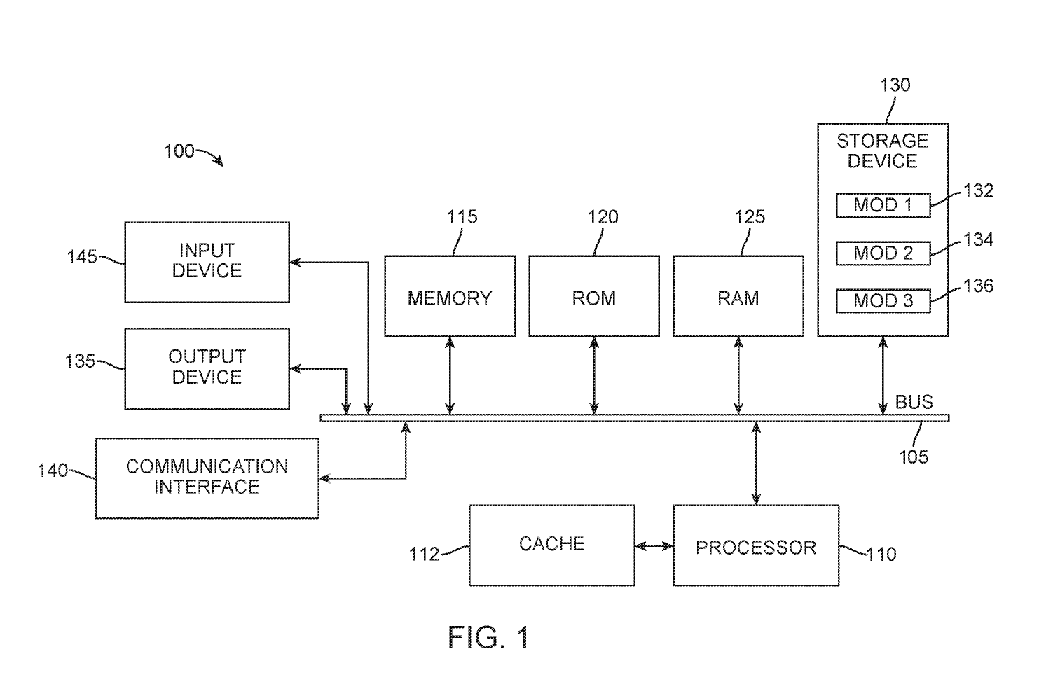

The present disclosure addresses the issues raised above. The disclosure provides several example implementations of the concepts disclosed herein. First, a general example system shall be disclosed in FIG. 1, which can provide some basic hardware components making up a server, node, or other computer system.

FIG. 1 illustrates a computing system architecture 100 wherein the components of the system are in electrical communication with each other using a connector 105. Exemplary system 100 includes a processing unit (CPU or processor) 110 and a system connector 105 that couple various system components including the system memory 115, such as read only memory (ROM) 120 and random access memory (RAM) 125, to the processor 110. The system 100 can include a cache 112 of high-speed memory connected directly with, in close proximity to, or integrated as part of the processor 110. The system 100 can copy data from the memory 115 and/or a storage device 130 to the cache 112 for quick access by the processor 110. In this way, the cache 112 can provide a performance boost that avoids processor 110 delays while waiting for data. These and other modules/services can control or be configured to control the processor 110 to perform various actions. Other system memory 115 may be available for use as well. The memory 115 can include multiple different types of memory with different performance characteristics. The processor 110 can include any general purpose processor and a hardware module or software module/service, such as MOD 1 132, MOD 2 134, and MOD 3 136 stored in the storage device 130, configured to control the processor 110 as well as a special-purpose processor where software instructions are incorporated into the actual processor design. The processor 110 may essentially be a completely self-contained computing system, containing multiple cores or processors, a bus (connector), memory controller, cache, etc. When implemented as a multi-core processor, the processor 110 may be symmetric or asymmetric.

To enable user interaction with the computing device 100, an input device 145 can represent any number of input mechanisms, such as a microphone for speech, a touch-sensitive screen for gesture or graphical input, keyboard, mouse, motion input, speech, and so forth. An output device 135 can also be one or more of a number of output mechanisms known to those of skill in the art. In some instances, multimodal systems can enable a user to provide multiple types of input to communicate with the computing device 100. A communications interface 140 can generally govern and manage the user input and system output. The system 100 is not restricted to operating on any particular hardware arrangement and therefore the basic features here may easily be substituted for improved hardware or firmware arrangements as they are developed.

The storage device 130 may be a non-volatile memory, such as a hard disk or other type of computer readable media which can store data and that is accessible by a computer. Examples of such media include, without limitation, magnetic cassettes, flash memory cards, solid state memory devices, digital versatile disks, cartridges, random access memories (RAMs) 125, read only memory (ROM) 120, and hybrids thereof.

The storage device 130 can include software modules 132, 134, 136 for controlling the processor 110. Other hardware or software modules/services are contemplated. The storage device 130 can be connected to the system connector 105. In one aspect, a hardware module that performs a particular function can include a software component stored in a computer-readable medium in connection with the necessary hardware components, such as the processor 110, connector 105, display 135, and so forth, to carry out the function.

The hardware components described above can be implemented locally for an entity performing the functions disclosed herein or could be implemented in a cloud-based infrastructure or a virtual environment. The particular computer implementation of the tokens and smart contracts described herein can be on any underlying platform. The smart contract can be built upon the Ethereum platform with a permissionless or public blockchain, or Quorum, which is based on Ethereum but provides a private or permissioned blockchain with restrictions on who is allowed to participate. Other examples of permissioned blockchains include the IBM Hyperledger Fabric and R3 Corda. Any permissioned or permissionless blockchain platform can be used to implement the smart contract.

In general, the blockchain network works as follows. An entity will request a transaction. The transaction in the present case involves the elimination of the unregulated token and the repackaging or creation of a new remediated token. The request is broadcast to a peer to peer network that consists of numerous computer nodes. The network of nodes will validate the transactions and the user's status using validation consensus algorithms. The output will yield a verified transaction that can result in both the removal of the original token and the creation of the new remediated token. Once verified, the transaction can be combined with other transactions to create a new block of data for a distributed ledger. The new block is added to the existing blockchain in a way that is permanent and unalterable, and the transaction is complete. The blockchain nodes will collectively adhere to the protocol for internode communication and the validation of new blocks. One benefit to a blockchain network is that the data in any given block cannot be altered retroactively without alteration of all subsequent blocks which requires the consensus of the network majority according to the consensus algorithm. Blocks in the blockchain network hold batches of valid transactions that are hashed and encoded into a Merkle tree. Each block includes the cryptographic hash of the prior block in the blockchain linking the two. The linked blocks form the chain. It is an iterative process that can confirm the integrity of the previous block all the way back to the original genesis block.

In one example, Ethereum replaces bitcoin's more restrictive language (a scripting language of a hundred or so scripts) with a language that allows developers to write their own programs. In this scenario, this disclosure provides a smart contract to manage a remediation process. Ethereum allows developers to program their own smart contracts, or ‘autonomous agents.’ The language is ‘Turing-complete’, meaning it supports a broader set of computational instructions. Smart contracts can (1) function as ‘multi-signature’ accounts, so that funds are spent or actions occur only when a required percentage of people agree, (2) manage agreements between users, say, if one buys insurance from the other, (3) provide utility to other contracts (similar to how a software library works) and (4) store information about an application, such as domain registration information or membership records. In a remediation process, the functionality might be initiated via multiple signatures which can include one or more of a buyer signature, an issuer signature and a regulatory signature. In one example, a smart contract could be programmed such that a remediation process is only initiated for a token or a group of tokens based on a first signature from a regulatory body which has confirmed the good faith activities of the issuer. The signature can be applied across all tokens, or group of the tokens (where, for example, leadership tokens of the issuer might be excluded) that are made available for remedial action. The buyer, upon indicating, via a user interface they desire the remediation approach, can provide a signature to confirm or initiate the process. The issuer might also need to provide a signature to initiate the process. The regulatory body signature might also be of a certain type or subtype. For example, one signature might indicate that the issuer acted in good faith and that certain parameters should be applied when converting nonregulatory tokens into new remediated tokens. Another regulatory signature might indicate that the good faith actions of the issuer are in question or that the issuer acted in bad faith. This signature could cause a different set of parameters to be implemented which can be more restrictive or different in terms of, for example, tokens owned by company executives relative to buyers of the tokens who have no company authority.

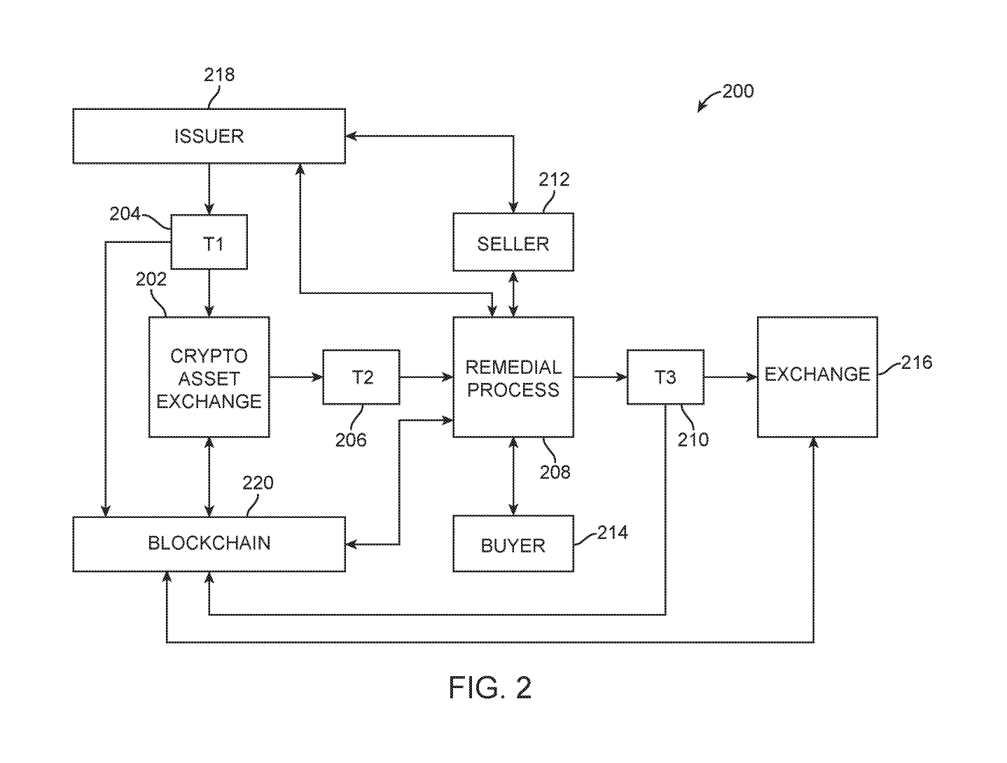

Having introduced the basic system embodiment in FIG. 1, the disclosure turns to the other figures. FIG. 2 illustrates an example framework 200 under which illegal offerings of tokens can be remedied. An illegal token offering 204 is sold by an issuer 218. The tokens T₁ (204) represent the illegal offerings which are recorded on a blockchain network 220 and traded on a crypto currency asset exchange 202 that causes a recordation of new owners of each token to occur on the blockchain 220. Assume in this example that the tokens T₁ were not properly exempted or registered pursuant to Section 5 of the Securities Act prior to their offering. Assume, as described above, that the tokens T₁ are later deemed to be securities, and therefore must be delisted from the crypto currency asset exchange 202. The issuance of such tokens, in many instances, was innocent from the viewpoint of the issuer 208. At the time of issuance, the regulatory climate surrounding ICOs and digital assets was unclear and the DAO report and SEC guidance came out after many ICOs had already occurred.

Tokens not properly registered but traded on the exchange 202 might be delisted from the exchange. The tokens T₂ (206) represented the delisted tokens that are “orphans” with value but no exchange upon which they can be listed for trading. The problem that this disclosure addresses is how to reclaim or enable the value contained within the delisted tokens T₂ (206) to be redeemed in terms of fairness for the purchasers.

The present disclosure provides both issuers and purchasers of tokens a chance to remediate the illegal offerings via a remedial process 208. The SEC 212, by enabling a remedial process, will be able to both encourage compliance with federal securities laws and ensure greater consumer protection. The remedial process 208 is preferably implemented via a smart contract which is programmed and operable on the blockchain network. 220, to carry out the functionality disclosed herein. In one aspect, as part of the remedial process, the issuer 218 will communicate with the SEC 212 and confirm that they acted in good faith in conducting their ICO. The SEC 212 shown in FIG. 2 represents a computer system programmed to provide an interface (i.e., a graphical user interface) which enables issuers to provide confirmation data regarding the history and experience of conducting their ICO and in which they can explain or confirm or verify that they acted in good faith. Such graphical user interface can seek information about the date of their ICO, their understanding of federal securities laws, information about legal guidance they may have received in which they were instructed that they did not need to comply with federal securities laws, and so forth.

Assuming that the issuer 218 is confirmed by the SEC 212 to have acted in good faith, then a remedial process 208 can be initiated. The SEC 212 might provide a signature as part of a multi-signature process to the smart contract 208. The remedial process can function or be performed on a blockchain network 220 via the smart contract. The SEC 212 can communicate data to the remedial process 208 which can authorize the initiation of the remedial process for tokens issued by the issuer 218. In one aspect, the remedial process essentially remediates the illegal offerings by retroactively engaging in the appropriate filings under Rule 56, Regulation A, Regulation CF or other appropriate regulation. The retroactive registration process can be accompanied by a right of rescission to all purchases of the original tokens which can allow them to receive a refund, should they not want their investment to carry over into a new remediated token T₃ (210) which can be recorded on the blockchain 220 or a separate blockchain generated via a fork or a hard fork of the original blockchain 220. The creation of a new remediated token, as disclosed herein can involve destroying the original token and creating the new remediated token all in connection with the same blockchain network recording these transactions. In another scenario, a blockchain can be forked and a new chain created for the remediated tokens. For example, a hard fork is a rule change such that the software validating according to its old rules will see the blocks produced according to the new rules as invalid. In a hard fork, all nodes meant to work in accordance with the new rules need to upgrade their software. It is known historically that a theory them has hard forked to make whole, the investors in the DAO because the original Blockchain had been hacked. The fork caused a split creating Ethereum and Ethereum Classic chains. The process of creating new remediated tokens can also include a forking of the original Blockchain with the unregulated tokens into a new chain that records remediated tokens.

The remediated token, for example, can be repackaged as a Reg D, Reg A, or other regulated category of security. The remedial process 208 can be carried out by a blockchain-based smart contract 220 that can, based on an identification of the current token holders, present purchasers 214 with the right of rescission. For buyers that exercise the right of rescission, they would receive a refund if they so choose. Those who desire a new remediated token T₃ (210) will have their original tokens T₂ (206) extinguished and have a new remediated token issued that can then be placed in the exchange 216 and traded as a security. The trades of the tokens via the exchange 216 can also be recorded on the blockchain 220 or a separate blockchain. The smart contract, operating as part of the remedial process 208, can cause the elimination or destruction of the illegally issued tokens T₂ (206) and the issuance of the remediated tokens T₃ (210) with the recordation of such activities on the blockchain network 220.

In this scenario, the SEC 212 will satisfy the duties to protect investors, maintain fair, orderly, and efficient markets, and facilitate capital formation.

The following is example code can be referenced for some functionality that can be related to the remediation process. For example, the process is described below in the code related to destroying tokens can be utilized to eliminate illegally issued tokens T₂ (206) as part of the remedial process prior to issuing new tokens T₃ (210). The token construction code below can provide an example of how to create a new remediated token T₃ (210) via the smart contract. The code below is exemplary and not meant to be exclusive.

pragma solidity;

```
interface tokenRecipient { function receiveApproval(address _from, uint256 _value, address
_token, bytes _extraData) external; }
contract TokenERC20 {
  // Public variables of the token
  string public name;
  string public symbol;
  uint8 public decimals = 18;
  // 18 decimals is the strongly suggested default, avoid changing it
  uint256 public totalSupply;
  // This creates an array with all balances
  mapping (address => uint256) public balanceOf;
  mapping (address => mapping (address => uint256)) public allowance;
  // This generates a public event on the blockchain that will notify clients
  event Transfer(address indexed from, address indexed to, uint256 value);
  // This notifies clients about the amount burnt
  event Burn(address indexed from, uint256 value);
  /**
  * Constructor function
  *
  * Initializes contract with initial supply tokens to the creator of the contract
  */
  function TokenERC20(
    uint256 initialSupply,
    string tokenName,
    string tokenSymbol
  ) public {
    totalSupply = initialSupply * 10 ** uint256(decimals); // Update total supply with the
decimal amount
      balanceOf[msg.sender] = totalSupply; // Give the creator all initial tokens
      name = tokenName; // Set the name for display purposes
      symbol = tokenSymbol; // Set the symbol for display purposes
  }
  /**
  * Internal transfer, only can be called by this contract
  */
  function _transfer(address _from, address _to, uint _value) internal {
    // Prevent transfer to 0x0 address. Use burn( ) instead
    require(_to != 0x0);
    // Check if the sender has enough
    require(balanceOf[_from] >= _value);
    // Check for overflows
    require(balanceOf[_to] + _value >= balanceOf[_to]);
    // Save this for an assertion in the future
    uint previousBalances = balanceOf[_from] + balanceOf[_to];
    // Subtract from the sender
    balanceOf[_from] −= _value;
    // Add the same to the recipient
    balanceOf[_to] += _value;
    emit Transfer(_from, _to, _value);
    // Asserts are used to use static analysis to find bugs in your code. They should never fail
    assert(balanceOf[_from] + balanceOf[_to] == previousBalances);
  }
  /**
  * Transfer tokens
  *
  * Send \grave{ }_value\grave{ } tokens to \grave{ }_to\grave{ } from your account
  *
  * @param _to The address of the recipient
  * @param _value the amount to send
  */
  function transfer(address _to, uint256 _value) public {
    _transfer(msg.sender, _to, _value);
  }
  /**
  * Transfer tokens from other address
  *
  * Send \grave{ }_value\grave{ } tokens to \grave{ }_to\grave{ } on behalf of\grave{ }_from\grave{ }
  *
  * @param _from The address of the sender
  * @param _to The address of the recipient
  * @param _value the amount to send
  */
  function transferFrom(address _from, address _to, uint256 _value) public returns (bool
success) {
    require(_value <= allowance[_from][msg.sender]); // Check allowance
    allowance[_from][msg.sender] −= _value;
    _transfer(_from, _to, _value);
    return true;
  }
  /**
  * Set allowance for other address
  *
  * Allows \grave{ }_spender\grave{ } to spend no more than \grave{ }_value\grave{ } tokens on your behalf
  *
  * @param _spender The address authorized to spend
  * @param _value the max amount they can spend
  */
  function approve(address _spender, uint256 _value) public
    returns (bool success) {
    allowance[msg.sender][_spender] = _value;
    return true;
  }
  /**
  * Set allowance for other address and notify
  *
  * Allows \grave{ }_spender\grave{ } to spend no more than \grave{ }_value\grave{ } tokens on your behalf, and then ping the
contract about it
  *
  * @param _spender The address authorized to spend
  * @param _value the max amount they can spend
  * @param _extraData some extra information to send to the approved contract
  */
  function approveAndCall(address _spender, uint256 _value, bytes _extraData)
    public
    returns (bool success) {
    tokenRecipient spender = tokenRecipient(_spender);
    if (approve(_spender, _value)) {
      spender.receiveApproval(msg.sender, _value, this, _extraData);
      return true;
    }
  }
  /**
  * Destroy tokens
  *
  * Remove \grave{ }_value\grave{ } tokens from the system irreversibly
  *
  * @param _value the amount of money to burn
  */
  function burn(uint256 _value) public returns (bool success) {
    require(balanceOf[msg.sender] >= _value); // Check if the sender has enough
    balanceOf[msg.sender] −= _value; // Subtract from the sender
    totalSupply −= _value; // Updates totalSupply
    emit Burn(msg.sender, _value);
    return true;
  }
  /**
  * Destroy tokens from other account
  *
  * Remove \grave{ }_value\grave{ } tokens from the system irreversibly on behalf of \grave{ }_from\grave{ }.
  *
  * @param _from the address of the sender
  * @param _value the amount of money to burn
  */
  function burnFrom(address _from, uint256 _value) public returns (bool success) {
    require(balanceOf[_from] >= _value); // Check if the targeted balance is enough
    require(_value <= allowance[_from][msg.sender]); // Check allowance
    balanceOf[_from] −= _value; // Subtract from the targeted balance
    allowance[_from][msg.sender] −= _value; // Subtract from the sender's allowance
    totalSupply −= _value; // Update totalSupply
    emit Burn(_from, _value);
    return true;
  }
}
```

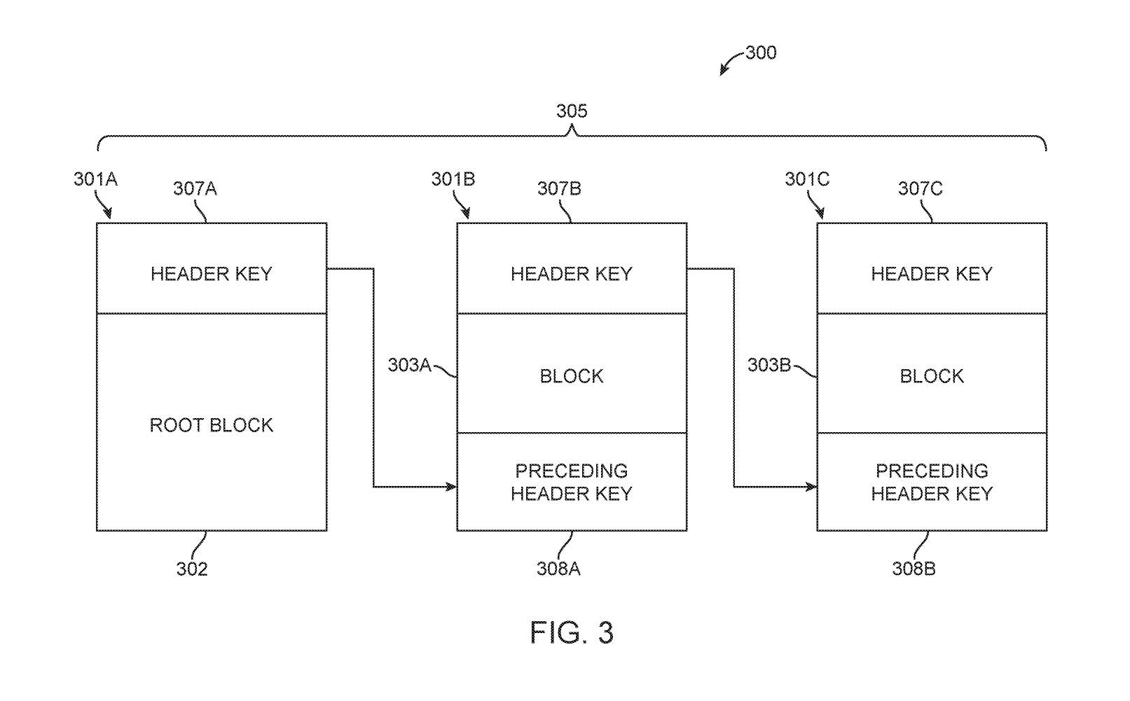

The original tokens T₁ (204) and the new remediated tokens T₃ (210) can each be generated as part of a blockchain (such as the blockchain 300 described below in the discussion of FIG. 3 or blockchain 220 in FIG. 2) and issued onto the blockchain. The token may also be associated with programmable logic enabling both one-time and regularly repeated routines to be performed in association with the respective token. The tokens can be related to an initial coin offering (ICO, a tokenized asset offering (TAO) a security token offering (STO) or any kind of digital asset offering.

FIG. 3 depicts one embodiment of a token or smart contract 300 in the form of a blockchain 305. It is understood that any number of more blocks can be included in a blockchain and the depicted blockchain 305 only provides a non-limiting example of a blockchain having three blocks 301A, B, C.

An initial block 301A includes a root block 302 and a header key 307A. Generally, header keys, such as header keys 307A-C, can be a hash key used to verify the integrity of the contents of the preceding block. Here, header key 307A is generated by hashing the contents of root block 302. Any modification to the contents of root block 302 that is hashed will result in a different header value that will not match the value of header 307A.

Block 301B includes a preceding header key 308A. Preceding header key 308A is generated by hashing the value of header key 307A. Therefore, any alteration to header key 307A will, when hashed, result in a different value than that stored in preceding header key 308A and so reveal whether the header key 307A has been altered.

Similarly, preceding header key 308B is generated by hashing the value of header key 307B and any new block added to the chain will include a preceding header key generated by hashing, e.g., the header key 307C of block 301C. Guarantees against post hoc edits are given by this intertwining of the header keys, preceding header keys, and contents of each block.

Root block 302 can contain information such as issuer identity, holder identity, and programmable logic dictating, as a non-limiting example, rules for enabling steps 202-228 of FIGS. 2A-C. Blocks 303A and 303B of blockchain 305 may include disbursement information, or remediation information, such as disbursement/remediation information. Blocks 303A and 303B may include sequential disbursement or remediation information, the information of 303A occurring before the information of 303B. As discussed above, in some embodiments, root block 302 can contain rules managing the remediation process. Furthermore, blocks 303A and 303B can contain updates to rules or revisions to remediation processes stored in root block 305. Alternatively, each block, 302, 303A, 303B, etc. can each include programmable logic superseding that contained in previous blocks, if any. In this way, each respective token may be converted from a non-regulatory token to a new remediated token, keep up with changes to disbursement or remediation rules as well as keep up with other information such as financial report or disbursement timing, and changes to ruling regulatory law.

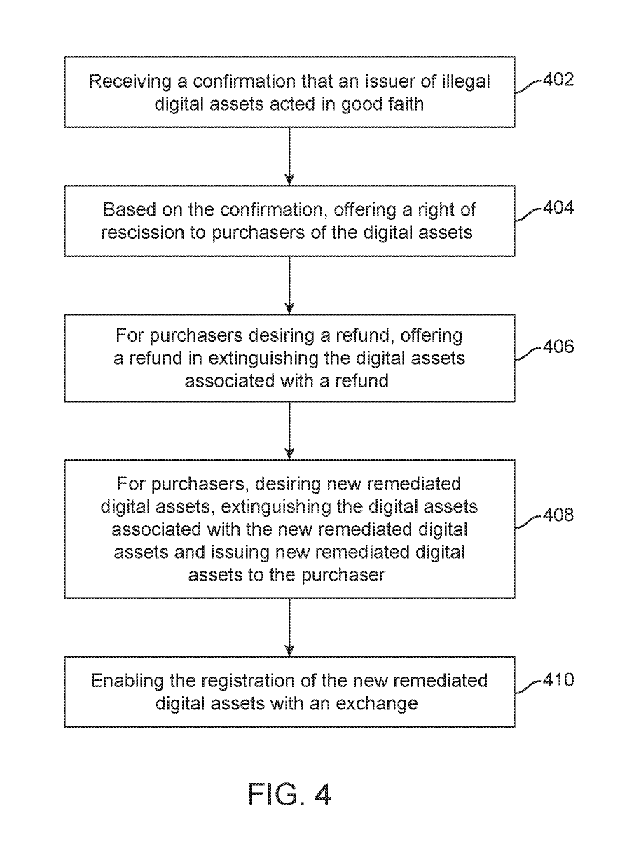

FIG. 4 illustrates an example method embodiment. The method can include one or more of the following steps in any order. The method includes receiving a confirmation that an issuer of illegal digital assets acted in good faith (402), based on the confirmation, offering a right of rescission to purchasers of the digital assets (404), for purchasers desiring a refund, offering a refund in extinguishing the digital assets associated with a refund (406), for purchasers desiring new remediated digital assets, extinguishing the digital assets associated with the new remediated digital assets and issuing new compliant digital assets to the purchaser (408), and enabling the registration of the new compliant digital assets with an exchange (410). Some of these steps can occur at a regulatory agency computer system while others might occur via a smart contract on a blockchain network. In one aspect, the smart contract could enable the user to select which regulatory structure the new remediated token will follow. For example, the buyer might be able to select whether their illegal tokens should be repackaged as a Reg D or a Reg A remediated tokens. In another aspect, data within the original tokens will be evaluated by the smart contract which can automatically determine or identify what the regulatory construct will be for the remediated tokens.

As noted above, a regulatory agency may change rules on how digital assets, tokens, etc. are regulated. The smart contract 208 disclosed herein can be in communication with regulatory agency servers or services 212 such that any change that is promulgated by a regulatory agency is automatically updated by or in the smart contract. In one scenario with respect to remediation, a question might exist of what the purchase date is for a purchaser for securities that can receive long-term capital gains treatment if the purchaser holds the securities for year. In a specific example, assume the purchaser purchased a digital asset on a crypto currency asset exchange 202 and held it for six months. Assume that the purchase digital asset then became deemed to be a security, and thus becomes orphaned (T₂ (206)) without the ability to be sold. If the buyer 214 proceeded through the remedial process 208 and received new remediated tokens T₃ (210) six months after the original tokens were purchased, the question arises whether they need to wait six months or a year from the creation of the new remedial tokens T₃ (210) to receive long-term capital gains treatment for the sale of those tokens.

The remedial process can include an initial notification to the buyer 214 regarding the remedial process and the current status of their token or tokens in the various options for remediation or refund. A graphical user interface can be presented to the buyer 214 which can be viewed through a browser, application, or other user interface which can enable the user to communicate with the smart contract and select a refund option, a conversion option, or choose a specific number of tokens. For one or more of the options, the user interface can vary and include selectable buttons are objects which can make the interaction with the user simple and efficient. The smart contract 208 can communicate with the user device 214 upon which is presented the user interface.

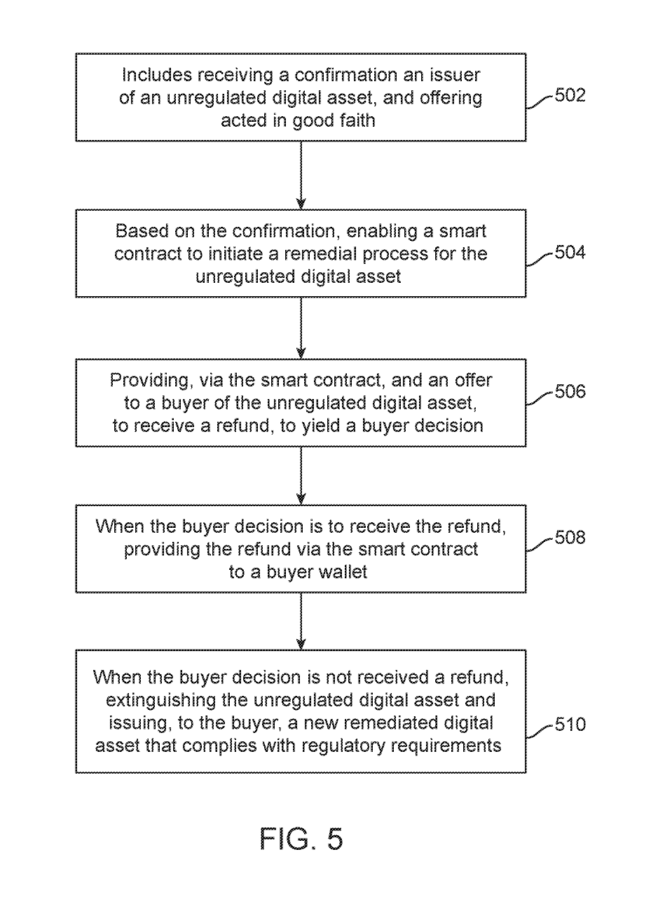

FIG. 5 illustrates another method example. The method includes receiving a confirmation an issuer of an unregulated digital asset offering acted in good faith (502), based on the confirmation, enabling a smart contract to initiate a remedial process for the unregulated digital asset (504) and providing, via the smart contract, an offer to a buyer of the unregulated digital asset, to receive a refund, to yield a buyer decision (506). When the buyer decision is to receive the refund, the method includes providing the refund via the smart contract to a buyer wallet (508). When the buyer decision is not to receive a refund, the method includes extinguishing the unregulated digital asset and issuing, to the buyer, a new remediated digital asset that complies with regulatory requirements (510). This can be recorded on a blockchain network 220 or can involve a forking of the original chain and generating a new chain for the remediated tokens.

In one aspect, the system would retroactively assign data associated with the new remedial tokens T₃ (210) that identify the original purchase date of the unregulated tokens T₂ (206) such that the buyer 214 is not prejudiced by the period of time the tokens were held but unregulated. As part of the creation of the new remediated tokens T₃ (210), the system can take into account these dates and issued those new tokens with the necessary data embedded therein.

The process described above relates to a regulatory change that essentially deemed originally issued tokens outside of the security regulations to be securities. In another example, restrictions on how long to hold the asset, foreign owner restrictions, restrictions on or definitions of accredited buyers, insider trading rules, etc., can be modified by or in the smart contract 208 in view of changes by regulating agencies. In other words, regulatory agencies 212 may make other types of changes that can impact digital assets. An “Oracle” or similar data feed distribution system could provide a trusted data feed about regulatory agency changes. In this regard, this aspect of the disclosure includes all of the steps and operations that may be implemented in terms of transmitting data receiving data, updating protocols and so forth. The embodiments related to these processes can be claimed from a standpoint of a regulatory agency updating a law or regulation and then promulgating that update via transmission of regulatory information out to a smart contract or smart contracts that are implementing policies as described herein for token offerings. The smart contract (represented by the remedial process 208) can then modify its processes according to the updated regulations. In another aspect, an embodiment might be claimed from the standpoint of the smart contract that receives updated regulations from a regulatory agency and then modifies its internal smart contract processes to accommodate or carry out future transactions based on the updated regulations. Data associated with or embedded within tokens can also be updated as well. Blockchain-based confirmations can be established to confirm to individuals following that particular smart contract that the proper updates have been implemented, applied and confirmed via the appropriate protocols for that blockchain.

In another aspect, the potential can exist for a dynamic parameter associated with the token to be altered after the initiation of the smart contract. There can be coordination and communication of such altered data or altered parameters to the smart contract which then adapts its performance according to the updated parameters. A dynamic parameter can also be related to the fact that a new remediated token T₃ (210) is related to a previous unrelated token T₂ (206) in take into account any number of factors that might need to be implemented to make the transactions or transition fair for the buyer 214.

The smart contract 208 could even engage in a confirmation process, via the blockchain, to confirm via external data, that the updated parameters are authorized for one or more tokens. The alteration of such parameters could be on a single token, a group of tokens, or all tokens. For example, one individual might have their tokens receive an increase to yield that differs from the originally embedded yield based on some action taken by the owner of the tokens or based on some other triggering event. A group of token owners may also have their tokens modified according to a characteristic of members of the group or some triggering event such as a change in regulation related to a timing of when a token can be sold, where it could be sold or to whom it could be sold. For example, an early adoption group of token purchasers can be given an increased yield based on some event. As another example, some token holders may be in a foreign jurisdiction and the regulations associated with foreign investors might change, which can trigger an alteration of the functions associated with that group of tokens. In another aspect, all token holders can have the parameters associated with their tokens altered or updated. In all these scenarios, the updated information can be provided to the smart contract in order for the realization of dividends or payouts according to the current information. A token holder or a group of token holders having tokens that are unregulated as originally issued can convert them to new remediated tokens and have any such data discussed above converted or transitioned to the new tokens.

The smart contract 208 disclosed herein can also receive any data embedded within the token, such as personalized data for the token holder, a date of a previously existing non regulatory associated token, or any of the yield, disbursement, and rewards data disclosed herein and insure that any actions associated with a respective token will be also transitioned to the new remediated token such that the same actions will be taken. The token data is also updatable by the token holder or the issuing entity, such as to change personalized data (such as to change a risk tolerance of the token holder or a change in risk to an expected disbursement), or to change yield data, disbursement data, etc. Any token data can be used to modify parameters or the performance of the smart contract to carry out the instructions of the smart contract.

One or more aspects of the tokens and/or a smart contract can be alterable in whole or in part, and, in another aspect, would not be alterable. For example, the confirmation and recording performance of the smart contract may be unalterable so as to maintain the immutable and trusted nature of recording and confirming financial transactions. However, parameters associated with tokens provided by an issuing entity could be alterable after they are issued, such that, where circumstances warrant, a change in the yield, disbursement or reward structure, the fact that a previous, related token was unregulated, or a modification of a timing parameter could be modified on a single token, group of tokens, or all token basis. For example, is part of an operating agreement of the issuing entity, members, or directors of the issuing entity might have timing restrictions on the sale or purchase of tokens issued. These timing restrictions can be built into the smart contract or the tokens themselves as disclosed herein. However, if there is a modification in the operating agreement such that those timing parameters are changed, a mechanism could be built into the tokens, or smart contract such that with the proper authorization (fingerprint identification, facial recognition, password protection, multiparty authentication, and so forth) the timing parameters could be modified. The transition process from nonregulated tokens to new remediated tokens will take into account any such changes and will continue to dynamically update any such parameters in the new remediated tokens.

As noted above, additional regulatory requirements can also exist that relate to timing. Offerings can have a hold period of resale for a certain period amount of time according to certain regulation. The amount of time might be, for example, twelve months from the offering. The tokens also might also be offered only to accredited investors or investors having a required citizenship or who live in a certain geographic location. The timing restrictions could be based on inappropriate times of making a sale as well. For example, a sale of tokens by a founder may not be made possible on the Friday afternoon before an extended holiday weekend for the purpose of trying to avoid public extensive knowledge of the sale. Restrictions on a sale of tokens could occur in a timeframe around a certain company notice, such as bad news about an audit or some other event. Such timing restrictions that might have been in an original non regulatory token can be converted and transferred over to a new remediated token. Any necessary adjustments could also be made as might be required by regulation. For example, a regulatory body might not allow a retroactive date for a previous non-regulated token. Therefore, a timing component built into a non-regulated token might have to be altered in a new remediated token. In another aspect, in order to encourage individuals to transition to regulated tokens, a regulator 212 might offer a shortened amount of total time for long-term capital gains treatment. For example, the regulator might allow the original purchase date to be maintained and the restricted time period for sale to be only six months, rather than one year. In another scenario, a timeframe associated with long-term capital gains treatment for one or more tokens might be related to whether the issuer acted in good faith or not. For example, where evidence exists where the issuer did not act in good faith, tokens purchased or owned by the issuer or leaders of the company associate with the issuer might have certain timing restrictions built into new remediated tokens that they respectively receive. Therefore, timing restrictions associated with new remediated tokens can be based at least in part on data received by the issuer 218 with respect to the initiation of the remedial process 208.

In one aspect, the regulatory system 212 can provide an interface for an individual who evaluates the good faith effort of the issuer 218 and enables the receipt by the system 212 of instructions with respect to retroactive application of timing requirements. Any number parameters might be received with respect to how new remediated tokens should be created. An administrator might review the request of the issuer 218 and provide certain parameters, such as no retroactive treatment, the extinguishment of a certain percentage of the owner tokens without remediation, or any other group of requirements. These requirements can then be communicated from the administrative system 212 to the smart contract remedial process 208 for implementation.

Characteristics or parameters associated with new remediated tokens T₃ (210) can also be implemented based on the qualification of a buyer 214. In the scenario of issuing a token offering, the qualification of the investor being an appropriately accredited investor can be built into the smart contract such that the smart contract validates the investor as accredited. The smart contract could confirm that the investor is a non-US person who is not required to be accredited or subject to the same restrictions. A third party service, such as an oracle that is a trusted source of the required data, can provide such data. Self reporting or some other functionality may also be built into the system to provide the credit worthiness of the investor or the buyer upon resale. Such functionality can be built into the smart contract and/or can be implemented via programming associated with each new remediated token T₃ (210).

The timeframe can depend upon one or more of a regulation governing a sale of the unique token and a regulatory status of the token holder. The method can further include, upon an attempt from a token buyer to purchase the unique token from the token holder within the timeframe associated with the restriction on selling the unique token, preventing, via one of the unique token and the smart contract, the token buyer from being able to buy the unique token.

The method can also include, upon an expiration of the timeframe associated with the restriction, enabling a token buyer to purchase the unique token from the token holder via the exchange 216.

For example, the smart contract 208 could receive an image or scan of a passport or a driver's license of the individual (potential purchaser or seller) and be able to confirm that the individual is a non-US resident. Access to banking records, previous investment history, asset holdings, credit worthiness data, and so forth can be provided through a data feed to enable the system to ascertain whether the user (buyer/seller) 214 is an accredited investor. This information can also be stored within the token itself or within the smart contract or both. Part of the information could be stored in one location, with other information stored in the other location between the token itself and the smart contract. The data could also be normalized such that personal information about the buyer or seller may be normalized into simple data representing that they are or are not an accredited investor, or that they have the proper citizenship without revealing what their citizenship is. For example, the token can hold the normalized information that the user is an accredited investor when they buy a Reg D token.

There are number of different attributes of an initial offering that can require remediation. For example, some attributes can include the fact that there were fewer than 2,000 holders of record. Most holders of record meet the requirements of accredited investor status. The offering may have been conducted on or off shore. To address any one or more of these attributes of the initial offering, the system may implement a process for remediation which can include one or more of creating a new company, providing all accredited investors with the option to receive rescission or to receive equity and the new company, providing a rescission to all unaccredited investors and/or conducting an exempt offering of equity in the new company under Regulation D.

In another example, the attributes of an initial offering might include that the holders of record were a mix of accredited and unaccredited investors or the total amount of funds raised was under $50 M. The possible process from remediation can include one or more of retroactively filing a form 1-A to remediate the improper offering. By taking this step, all original investors will have their equity or debt converted into equity or debt under Regulation A. Remediation can also include that the investors will be provided the option to participate in the Regulation A conversion. If they don't desire to participate, they will be provided their money back.

In another example, the attributes of an initial offering might include that there were more than 2,000 holders of record in the offering raised over $50 M. The process for remediation can include one or more of determining if the initial token issuance took place only to accredited investors, for example through a sample agreement for future tokens (“SAFT”), then, the issuer will file a remedial form D. All original investors will have their interests converted to equity or debt under the new filing or will be provided with rescission if they so choose. Otherwise, the remedy could be that the issuer will be required to file a form S-1 to remediate the improper offering. All original investors will have their interests converted to equity or debt under the new filing or will be provided with rescission if they so choose.

As noted above, tokens can have a timeframe associated with them under which they are not allowed to be resold. A US accredited investor who buys a Reg D token cannot sell it for twelve months. A timer or a clock can be built-in to at least one or more of the token and the smart contract. The timer or clock can take into account the remedial process and balance or accommodate a time in which the illegal token T₂ (206) was held as well as the time of purchase or creation of the new remediated token T₃ (210). A smart contract that is managing an ICO (which can include a TAO) could simply not allow tokens held by accredited investors who are under the twelve month timeframe to be sold. A hold would be built into the process. This is essentially providing protection for the person on the other side of the transaction of the coin holder who might unknowingly buy or try to buy tokens that are not allowed to be resold. The clock can count down to eleven months, ten months, and so forth until the twelve month timeframe is over and the token can automatically be able to be resold. All such timing requirements can be transitioned to a new remediated token in the remediation process managed by the smart contract.

There are a number of different mechanisms which can be implemented to enforce a timeframe restriction on the sale of the token. For example, upon the system receiving a request from a potential buyer to buy the token, the system could access data stored within the tokens sought to be purchased, which can include a built-in clock or timer, such that data can be ascertained from the token itself that because the timer is still running, the respective token cannot be sold. The smart contract can also operate a timer or maintain data identifying tokens which are still under timeframe restriction as well as data associated with previously associated tokens that have been extinguished, but that were issued illegally. Communication between the tokens and the smart contract can also occur. For example, a token can include a timer indicating a timeframe during which the token cannot be sold. Upon the completion of the timeframe, the token could provide notification to the smart contract that its timer has expired and that it is now available for sale. The smart contract, during the timeframe of restriction, could maintain a parameter associated with the respective token that the token cannot be sold. That parameter can be adjusted upon receiving the indication from the token that the restriction no longer applies. The timer built into a token can also be transitioned and created, reset, or maintained in a new remediated token.

With such timing mechanisms in place, if the investor tried to sell the token at six months, where the timeframe of restricted sales is twelve months, the system 216 can block the sale. The system can also provide instructions, notifications, or any other communication as might be triggered by an attempt to sell such a token prior to the completion of the regulatory requirement. For example, the government official 212 could be notified of the attempt of the sale as well as the token holder. Other notifications can be provided to the token holder indicating that the timeframe has now passed or notifications might be made public through communication channels that a respective token or group of tokens is now available for sale.

Different regulations can have different time frames. For example, a Reg S sale has a 40 day requirements. No clock is needed for a Reg A+ sale. In the context of the resale of such tokens, in some cases, a non-US citizen might purchase appropriately a token that a US resident could not buy. Thus, under a Reg D sale, if a non-US citizen wanted to purchase a token after six months, that sale might be allowed to proceed by the smart contract. However, the history of that sale can be stored within the blockchain, or within the token itself, or both, such that if those tokens were later sold to a US person, then the timer or clock returns back to the twelve month time period. Data regarding the history of the sale of a token can also be stored in parts between the token itself, and a smart contract or other blockchain database. Thus, in some cases, to retrieve the full history regarding the sales of a token, a requester might require accessing some data stored within the token itself and other data stored at a different location such as the smart contract or other blockchain database.

This approach can solve the problem for monitoring, archiving and auditing the trails of resale provisions. The smart contract can receive data about the seller, the buyer, the token, the timing element, and any other data, and process that data to allow a sale or place restrictions on the sale of tokens. Thus, with the timing procedures in place, an auditor would essentially have no work to do in that if a token was sold, by definition, the timing requirements would have been met as they are built into the token and/or smart contract.

A remedial process 208 can be implemented to overcome a hold on the sale as well, if possible. When the timeframe associated with the restriction on selling the unique token causes the smart contract to prevent a sale of the unique token to a token buyer based on a parameter, the method can include performing a remedial process to overcome an issue associated with the parameter and enabling the sale of the unique token to the token buyer.

For example, the data associated with the restriction can be analyzed or evaluated for a potential for remediation. If the potential buyer does not qualify as an accredited investor, but appears to be close to meeting the statutory requirements, a dialog could be initiated to indicate how close the potential buyer is to meeting the requirements and to see if any further information could be received regarding assets or income, or any other data required depending on what is needed, to see if further data can be retrieved to remedy the restriction. In other cases, a sliding scale approach could be utilized in which the status of an investor may not necessarily be a yes or no with respect to whether they are an accredited investor. For example, the qualifications associated with an accredited investor may be close enough that the buyer is allowed to buy a certain limited amount of the tokens, rather than an unlimited amount. For example, somebody who is a 75% accredited investor might be allowed to purchase 10,000 tokens and no more, where fully accredited investors will have no such limit. Such sliding scale variations can be built into one or more of the tokens themselves and the smart contract.

Furthermore, while some individuals may be limited based on their citizenship or geographic location, such restrictions may also have a sliding scale component in which a certain level of purchasing capability might be granted based on such factors.

In another aspect, the smart contract and have other capabilities, such as handling a right of first refusal in private company shares issued to employees, officers and directors. This is the type of provision where built into one or more of the tokens themselves or the smart contract itself, or both, when an attempt to resale private company shares is initiated outside of the right of first refusal provision, then the smart contract would block that sale. Inasmuch as a parameter is set or data indicates that the entity who has the right of first refusal has not been offered the sale yet. Again, these types of events or restrictions can initiate a trigger which can notify one or more affected parties. For example, the party who owns the right of first refusal can receive a triggering notice that an attempt was made to sell the shares prior to their opportunity to buy. A user interface can be presented to the party with the right of first refusal which, when initiated, can present them the opportunity to bid or to purchase the tokens given the interest by the other party.

These kinds of provisions can relate to any kind of encumbrance or parameter which can affect the freedom of a token holder to be able to resell the token. The smart contract can have built into it procedures for handling any type of issue, whether it is a timing issue, a regulatory issue, whether it relates to a status of the buyer of the token, whether it relates to a third party who has contractual rights to that token prior to us resale, whether it has to do with the price restriction which might indicate that a resale of the token should be within a certain price range, or a volume restriction, such that circumstances require that only one thousand tokens or more can be sold in batches, and so forth. All of these kinds of restrictions and remedial actions, including timing restrictions with possible remedial actions, can be built into the functionality of the smart contract and/or data held within the tokens themselves. Some or all of such restrictions can be remedied as part of a process of converting a nonregulatory token into a new remedial token as disclosed herein.

In another aspect of this disclosure, an anti-money laundering (AML) processes may also be built into the issuance of new remedial tokens. Such a structure can include AML procedures to identify purchasers and sellers. Know your client (KYC) requirements may also relate to being accredited or qualified purchasers, which is another important feature by way of investor protections. In a regulation D 506(c) offering under general solicitation, for example, the issuer can advertise to anyone and any inbound investor has to be accredited. A retail investor may not be allowed to make the purchase of a token offering under regulation D. These types of identification requirements and data associated with being a qualified investor can be embedded within one or more of the tokens or the smart contract or built into new remediated tokens as necessary. A verification and validation process for investors may be executed to confirm that an investor meets all regulatory requirements for a new remedial token. For example, a service could provide personalized verification data associated with a potential investor a token issuer or to a smart contract such that a particular token holder can be identified properly and qualified properly (e.g., does the inventors have enough income, net assets, experience, etc., to purchase the tokens?), and so forth, for regulation D offerings. The purchaser may provide access to a service or to their financial data such that an automatic access could be provided through an application programming interface (API), for instance, for analyzing their capabilities.

The smart contract can include programming or functionality that receives an initial identification of a potential purchaser of tokens in the offering, and accesses databases that are authorized by the potential investor to evaluate the credit worthiness or financial condition of the investor and returns a confirmation that the investor is accredited or not. The smart contract could access, through an API or other communication mechanism, the various entities holding the data (banks, mortgage companies, car dealerships, brokers, etc.), which may be about, among other things, a home value, a bank account, investments, debt, historical financial data, and so forth for the investor to make the evaluation. The smart contract could also perform this function on a periodic basis as in some cases accreditation is to occur every 6 months. The smart contract could also access data about the previous history of the illegally issued tokens to identify dates or circumstances of the issuance of those tokens, which can impact the type of the newly remediated tokens or the allowed characteristics of buyers. The tokens could also include parameters that tie the ongoing yield, dividend and/or rewards to the accreditation confirmation of the token holder. For example, the yield could go down or up if the smart contract, 6 months into the operation, identifies that the token holder is no longer accredited, some other event occurs which increases or decreases risk, and so forth. Any of these values can also be carried over from unregulated tokens to new remediated tokens.

Once the token is embedded with an accredited holder status, the smart contract may be subject to various resale regulations. For example, the token may be subject to a 12-month resale provision for tax purposes or other restrictions in the United States. If someone tries to transfer the token, a multisignature confirmation approach could be implemented through the smart contract that prevents the token holder from selling that token before the 1-year anniversary, which can be calculated to include time that an associated non-regulated token was held. Thus, regulations can be implemented through the smart contract in this manner. As noted above, updates to regulations can also be provided to the smart contract such that its processing of dividends, restrictions on sale, and so forth can be according to the current regulatory environment.

In the scenario of a Regulation S offering, the token can be embedded with a regulatory parameter, which allows a user to sell the token to a foreign investor after 40 days. If a US investor then later buys that token, the smart contract can cause it to return to a 12-month sale restriction. Again, any or all of these restrictions can be carried over from a nonregulatory token into a new remediated token.

The discussion above provides a number of examples of how different offerings with different regulatory structures can be baked into tokens to identify the type of offering associated with the token, which information can then be communicated to or also provided to a smart contract that is carrying out the lifecycle of the tokens and their return on investment provisions.

In another aspect, the token can be embedded with a provision that identifies the token as owned by an insider of the issuer. The identification can provide more detailed information about the insider or may be more generic. For example, if the token is owned by the CEO of the issuing entity, that information could be made available or embedded within the token. If the token holder is more of an affiliate of the issuing entity, and thus not in a key strategic position, that information could be provided as well. Information might also be included in this scenario, with respect to the good-faith nature of the token offering by the issuer. This information may be useful in terms of providing transparency when tokens are sold or when dividends rewards or yields are provided. This feature can be provided as an aspect of investor protection. Also, in the case of a potential purchaser of the issuing entity or of an individual token or a group of tokens, the purchaser can be aware that he or she is buying insider tokens. This information can also be dynamic where the status of a token holder may change. For example, an individual who buys tokens from the issuing entity may later join the company on their Board of Directors. Further, a CFO may hold tokens as an insider that then leave the company and no longer have an insider status. The parameters that may be embedded within individual tokens can include data that encompasses and reports the various ways of defining an insider for purposes of that token or issuing entity. Again, in the context of converting nonregulated tokens through a remediation process into new remediated tokens, such information can have individual bearing on restrictions or requirements or data that is transitioned into the new remediated tokens. Penalties may be built into the transacted or transition data based on a level or value associated with whether the actions of the issuer were in good faith in an original ICO or not. For example, tokens issued to a CEO may be only transitioned to a new remediated token of an individual who is not an officer of the company given the bad faith actions associated with the original token offering.

In addition, the parameters that provide dividends yields or rewards may also vary for insiders. The parameters may be enhanced or reduced for purposes of fairness or transparency where insider traders receive a specialized type of return. Using the smart contract, data can be provided with respect, for example, to different aspects of the return on investment for insiders versus average investors. All of the insider tokens can be tracked for their particular type of return relative to other investors. Therefore, if the insider tokens receive a higher yield or return, that information can be made transparent to all token holders or to those who have access to the data from the smart contract. Furthermore, such parameters may also be adjusted or maintained through the process of extinguishing nonregulated tokens in exchange for new remediated tokens.

The smart contract can receive information about citizenship, geographic location, accredited characteristics, and so forth of sellers and buyers of tokens in a marketplace and cause or implement any regulatory changes in those transactions. Thus, restrictions on sale, modifications of yield, dividends, and/or rewards, changes in blockchain analyses and recordation requirements, and so forth, can be implemented by the smart contract as programmed and can be based on the various points of data that would be required to carry out regulatory requirements. All of the incoming and outgoing communications associated with the smart contract are included within this process.

The various external data sources would provide such information. For example, an investor in a foreign country as well as an investor in the United States could register with the service, which provides their confirmed status, of any type, which impacts how regulations are applied. Citizen status or changes to citizen status could be provided to the smart contract, which could cause a change in a regulatory requirement or function of the smart contract. Various embodiments disclosed herein can be claimed from the standpoint of the smart contract, the token holder, the issuer, or from the standpoint of the third party service providing accreditation or other data. Thus, any steps performed by any individual entity in this process can be described and claimed as part of this disclosure. The remediation process disclosed herein might also vary depending on the characteristics of the investor as being in a foreign country or within the United States. Any such data as described above can be applied to impact the particular way in which a nonregulated token is converted into a new remediated token.

In one aspect, investors could have in a digital wallet stored locally, or at a network service, verified data that identifies and is trusted to properly identify their accreditation status, citizenship, geographic location, and so forth. In some offerings, self-identification of accreditation is not acceptable. Thus, in situations where the issuing entity has the obligation to confirm the accreditation status of a potential token holder, using an accreditation wallet or network-based confirmation service can enable the issuing entity to fulfill their requirements through the implementation of the smart contract which would communicate with and retrieve the authorization data from an accreditation digital wallet or an accreditation service. For example, the data can be retrieved through a specific API with a holder of an individual retirement account (IRA) or other investment accounts of the buyer, the buyer's mortgage holder, or any other entity that has relevant data associated with the buyer's accreditation status. The smart contract can be authorized to retrieve that data and confirm their status to fulfil the issuing entity's obligation.

A third party service can also perform this function. The accreditation for a buyer can also be stored on a blockchain and verified through a verification algorithm. Each periodic confirmation of their accreditation status can be added to the buyer's accreditation blockchain. This approach improves the process by resolving the inherent conflict of the situation where the issuer is required to confirm the accredited status of potential buyers. Further, issuers may not even really have the capability or expertise to properly accredit buyers. Using a digital wallet or third party verifier enables a token to be created and embedded as a “clean” token that is issued to a confirmed accredited buyer. Such a clean token is better configured for resale as well. Multi-signatory requirements can be required for any aspect of this disclosure to confirm data or for security purposes. The accredited nature of a buyer can also be taken into account with respect to how a nonregulated token is converted or transitioned to a new remediated token. For example, in accredited status might cause the original purchase date of the nonregulated token to govern with respect to the treatment of long-term capital gains tax.

Another aspect of this disclosure relates to how to deal with mergers, acquisitions, or other changes in management of the issuing entity. All the following principles can also apply across the transition from a nonregulated token to a new remediated token. Such a transition may also justify a revision or change with respect to a previous parameter related to mergers, acquisitions, or other changes in the managing of the issuing entity. For example, the tokens in this scenario are not on the capital table and would not be on the issuing entity's books as debt as the tokens are not a debt obligation. As there is a yield/reward/disbursement component to each token, there is a potential question of what happens to the token and its associated disbursement in response to a change of ownership event. A potential issue can exist if they stand to lose their tokens in an acquisition. Several approaches can be implemented to enable the token holders to retain value or have value transferred in the context of a merger or acquisition. These solutions can protect the token holding investor when faced with such events. In some scenarios such tokens can be transitioned to new remediated tokens that are deemed securities such that their fundamental nature changes as well (from a debt instrument or a disbursement instrument to an equity instrument).

One approach could simply be to enable the issuing entity and the purchasing entity to deal with the token holders in the event of a merger or acquisition. For example, if a company issues stock and raises $2 M in normal regulated stock but then receives $10 M from individuals who receive tokens, in the sale of that company, the regular stockholders would, in the standard fashion, receive capital gains income in process. However, the issuing entity or selling entity could arrange with the acquiring company to pay out whatever yields, dividends, or agreed-upon disbursements to the token holders as part of a merger process. Where such tokens exist, any such token could be transitioned to a new remediated regulatory token where the process can equate a particular value of the token of a first type, to an equivalent or remediated value in a new remediated token that is considered a security and tradeable on an exchange.

In another aspect, rules or parameters for dealing with a merger process may be embedded within the tokens. In such a scenario, information about the merger process, such as a signing of a letter of intent, or the initiation of merger discussions, the completion of due diligence, and the final funding event could be provided to the smart contract which could carry out the merger parameters that are embedded within the tokens or programmed within the contract. A merging process could also be programmed into the smart contract independent of any specific merge instructions embedded within the tokens. Such data, rules or parameters can also be carried over into new remediated tokens.

In one aspect, the smart contract could be programmed to prepare for a merger event. Programming within the smart contract can be provided to the store historical information through the blockchain which can be utilized through a programmed algorithm to predict the future performance of the tokens. For example, if a token holder paid $1000 for the token and had received in dividends, yields and/or rewards a return of $1000 on their investment and there was an expected additional $2000 of income from that token over a period of several years, that information could be built into the smart contract such that a report could be provided which would provide information about an expected future income for that token holder. That data could be utilized to pay that token holder a certain amount in the event of the merger. The seller and the acquirer could agree that at the conclusion of the merger the smart contract report with respect to the token holders would be honored such that the token holders would receive compensation as part of the merger. The buying entity could also transfer the tokens to the new entity such that the same dividends/yields or rewards would continue to be paid.

The information associated with the token value as determined by the smart contract can be provided as a value to the parties and negotiated between the issuer and the acquirer. In one example, assume that on Jul. 1, 2017, data was provided to the smart contract that indicated that a merger had formally begun and that the merger was expected to take nine months. The smart contract could predict the performance of the tokens and the expected future value gains to the token holders, nine months from Jul. 1, 2017. In one example, assume that it is predicted that all of the token holders can expect on Apr. 1, 2018, that they will have an aggregated additional yield, dividend and/or rewards of $20 M over a three year period. A report can be provided and utilized to enable the acquiring entity to make an offer or negotiate a buyout of the token holders. In one aspect, the purchasing entity may directly buy the interests of the token holders at which point the acquiring entity may become the token holder and receive, in the above scenario, the yield, dividends and/or rewards would be received by the new owner of the tokens. The purchasing entity could also then resell the tokens to new buyers. The original token holders may want to have their tokens transitioned to the new entity at full value or agree upon a discount to maintain the tokens in place. Of course the buyer and the token holders could also negotiate the sale of the tokens to the new buyer of the issuing entity. The report and prediction of the value of the tokens in the future from the smart contract could be provided to enable the value to be ascertained. Any of this data can be carried over into a new remediated token.

In another aspect, the issuing entity could place money in an account, a crypto currency or put some value at a location that is accessible by the smart contract such that if the sale event or merger event occurs, it could trigger a payment to the token holders. The trigger could occur before the merger, during the sale, or after the sale and the sale may be to fund the token holder payment account. The smart contract could be structured such that the payment would be paid to the token holders if they had not received a certain return on their investment. For example, if a token holder purchased $1000 worth of tokens and had only received $500 in dividends prior to a merger event, the issuing entity could be required to retain $600 such that as the merger event is reported to the smart contract, and if it is confirmed that it will occur or is occurring, that the token holder receives $600 from the account, which enables them to both receive their initial purchase price plus a profit. An amount of money in a holding account could also be required by the smart contract and could be adjustable as returns are provided to the token holders. For example, the amount in the account could be a dwindling amount as the token holders receive dividends such that as the token holders receive their initial payment plus a certain percentage of profit, say 20%, that the holding account then can be depleted. At this point, in one scenario, the token holders would be potentially open to losing their continued yield in the event of a merger but at the very least, the smart contract ensured that they received their initial investment plus some profit. Again, such information as described above can be maintained across the transition from a nonregulated token into a new remediated token.

In yet another aspect, the tokens can be self-extinguishing or self-liquidating at the change in ownership event or at a remediated event or upon or prior to a delisting from an exchange. One or more steps could potentially need to be taken before such self-extinguishing or self-liquidating event would occur and in connection with the merger event, delisting event, or transition to a remediated status. In one aspect, once a smart contract receives the data that a merger has occurred or the type of change event has occurred or is likely to occur (like a delisting from an unregulated exchange), the smart contract may simply cease to operate and all of the associated tokens may self-extinguish. For example, if the merger data indicates that a merger will occur within the next three months with a certain probability, the smart contract could require a self-liquidating event where the issuing entity is required to pay the token holders a certain amount, which can be established based on the amount of capital returned, the amount of profit or rewards, as well as the predicted profit or rewards in the future, such that token holders receive at least their capital and a certain return from the issuing entity. In this scenario, the issuing entity may need to go into debt in order to pay the token holders, but that that would end up being in debt obligation on the record as part of the merger transition. Again, all of this functionality in a token can be transitioned properly from a nonregulated token to a new remediated token. For example, the smart contract 208 could not only include a self-extinguishing event or self-liquidating event but based on such triggers, the smart contract can include a self-remediation event. In such a scenario, based on the potential triggers as described above, as well as other trigger such as the potential of a delisting of a nonregulated token or a change in regulation that can indicate that a nonregulated token should have been deemed a security upon issuance, the smart contract could automatically self-remediate a token, group of tokens, or all the tokens such that notices are provided to token holders regarding the remediation process, there are options to choose a refund or rescission or to maintain and keep new remediated tokens, interactive options as part of user interface to receive user instructions, and so forth.

The protection features disclosed herein could be implemented as a toggle like feature within the smart contract that is essentially turned on when a merger event, or potential delisting, or transition event to a remediated token, is initiated or on the horizon. Part of the obligations of the issuing entity to the token holders could be to provide such data with respect to mergers or regulatory changes (like the Clayton letter indicating the tokens in ICOs are securities) to the smart contract so that the protection provisions can be implemented in the event of a merger or change in regulatory status. A holding account or escrow account which stores some money or other value designed to protect token holders again could be utilized such that if merger discussions begin and the smart contract is not notified, or if a merger or other event occurs without the protections procedures implemented, that the value within the holding account could be retrieved and distributed to token holders in order to enable them to be made whole or receive an expected return. In other words, penalty provisions could be provided to urge the issuing entity to properly report merger discussion status to the smart contract.

By reporting the information associated with a merger, delisting, or other event, the smart contract could begin to implement protection features, such as increasing or enhancing the yield dividends or rewards. For example, if, at the initiation of merger discussions, it is expected that the merger negotiations will last one year, the smart contract could utilize the amount of capital returned, the amount of profit received, and the predicted return over that next year to make adjustments for the token holders. In one example, in order for token holders to receive a predetermined return on their investment, the smart contract might enhance all of the returns such that essentially a normal two year expectation of return would be provided to token holders within one year. In this scenario, when there tokens become extinguished as part of a merger event or as a transition to new remediated tokens, the token holders are made whole without the need for the acquirer to deal with the tokens.

According to the agreed-upon parameters within the smart contract, the token holder protection provisions might also be dynamically adjusted as reports are provided throughout the merger negotiation process such that if the likelihood of a merger decreases and the process starts to break down, the return algorithms could potentially adjust returns back to their normal expected and programmed amount. The smart contract could also be implemented such that if accelerated returns are provided because of the expectation of a merger, but the merger falls through, the smart contract could reduce the returns over a period of time such that a year after the failed merger of events, the return algorithm has balanced out the returns for that period of time and is back onto a normal return schedule as though no merger discussions had occurred.

The information on the performance of the token could also be utilized to provide a value to that tokens which might be similar to a bondholder value. Depending on what the yield value is, that token might be sellable in a marketplace and the data held within the smart contract on its historical performance as well as his predicted performance can be used to establish that value.

In the issuer side of the smart contract, for example, with any of Reg A+, Reg D 506(b) or (c), Reg F, Reg C, or any other offerings such as remediated offerings, the regulatory requirements for those offerings on the issuer side can be built into the token offerings disclosed herein. The details of any regulatory statute that might apply are incorporated by reference and considered as part of this disclosure, as would be known by one of skill in the art. Any component of the requirements can be built into the tokens as well as the functioning of the smart contract. Similarly, any regulatory requirements on the buying entity, such as resale restrictions, foreign investor sale requirements, holding periods, accreditation levels, and so forth can also be built into the tokens and carry over with the same structure or a modified structure in a new remediated token.

In one aspect the profit participation parameter can encompass a specific profit participation component or an equity share or equity position in the issuer, such as securities representing an ownership position in a publicly traded corporation. It could also represent a creditor relationship with an entity or rights to ownership associated with a stock option. They can also include a debt security such as a bond, certificate of deposit or a collateralized security. A hybrid security could also be used, which blends the debt and equity security.

In some embodiments, the computer-readable storage devices, mediums, and or memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. Any token or structure/function disclosed herein can apply to a tokenized asset offering or a security token offering.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

It should be understood that features or configurations herein with reference to one embodiment or example can be implemented in, or combined with, other embodiments or examples herein. That is, terms such as “embodiment,” “variation,” “aspect,” “example,” “configuration,” “implementation,” “case,” and any other terms which may connote an embodiment, as used herein to describe specific features of configurations, are not intended to limit any of the associated features or configurations to a specific or separate embodiment or embodiments, and should not be interpreted to suggest that such features or configurations cannot be combined with features or configurations described with reference to other embodiments, variations, aspects, examples, configurations, implementations, cases, and so forth. In other words, features described herein with reference to a specific example (e.g., embodiment, variation, aspect, configuration, implementation, case, etc.) can be combined with features described with reference to another example. Precisely, one of ordinary skill in the art will readily recognize that the various embodiments or examples described herein, and their associated features, can be combined with each other in any combination.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa. The word “exemplary” is used herein to mean “serving as an example or illustration.” Any aspect or design described herein as “exemplary” is not necessarily to be construed as preferred or advantageous over other aspects or designs.

Moreover, claim language reciting “at least one of” a set indicates the one member of the set or multiple members of the set satisfy the claim. For example, claim language reciting “at least one of A, B, and C” or “at least one of A, B, or C” means A alone, B alone, C alone, A and B together, A and C together, B and C together, or A, B, and C together.

What is claimed is:

1. A computer-implemented method comprising:
receiving, via a processor, a confirmation an issuer of an unregulated digital asset, and offering acted in good faith;
based on the confirmation, enabling a smart contract operating on a blockchain network to initiate a remedial process for the unregulated digital asset;
providing, via the smart contract, and offer to a buyer of the unregulated digital asset, to receive a refund, to yield a buyer decision;
when the buyer decision is to receive the refund, providing the refund via the smart contract to a buyer wallet;
when the buyer decision is not received a refund:
extinguishing the unregulated digital asset and recording the extinguishing on the blockchain network; and
issuing, to the buyer, a new remediated digital asset that complies with regulatory requirements.

2. The computer-implemented method of claim 1, further comprising:
providing the new remediated digital asset to an exchange.

3. The computer-implemented method of claim 1, further comprising:
recording in the new remediated digital asset an original purchase price of the unregulated digital asset by the buyer for long-term capital gains treatment.

4. The computer-implemented method of claim 1, wherein extinguishing the unregulated digital asset and issuing the new remediated digital asset are recorded on a blockchain network.

5. The computer-implemented method of claim 1, further comprising:
transmitting a notice to the buyer, based on the confirmation, providing information to the buyer regarding the remedial process.

6. The computer-implemented method of claim 1, wherein parameters stored within the nonregulated digital asset are carried over in the remedial process to the new remediated digital asset.

7. The computer-implemented method of claim 6, wherein the parameters relate to one or more of an accredited status of the buyer, data associated with officers of the issuer, data related to timing of authorizations to sell, and data related to regulatory requirements.

8. The computer-implemented method of claim 1, wherein a timing associated with a sale of the new remediated digital asset is defined by when the buyer purchased the unregulated digital asset.

9. The computer-implemented method of claim 1, wherein a timing associated with a sale of the new remediated digital asset is defined by the issuing of the new remediated digital asset.

10. The computer-implemented method of claim 1, wherein issuing, to the buyer, a new remediated digital asset that complies with regulatory requirements further comprises forking an original blockchain recording the unregulated digital asset, to create a new blockchain for recording the new remediated digital asset.

11. A system comprising:
a processor; and
a computer-readable storage device storing instructions which, when executed by the processor, causes the processor to perform operations comprising:
receiving a confirmation an issuer of an unregulated digital asset, and offering acted in good faith;
based on the confirmation, enabling a smart contract to initiate a remedial process for the unregulated digital asset;
providing, via the smart contract, and offer to a buyer of the unregulated digital asset, to receive a refund, to yield a buyer decision;
when the buyer decision is to receive the refund, providing the refund via the smart contract to a buyer wallet;
when the buyer decision is not received a refund:
extinguishing the unregulated digital asset; and
issuing, to the buyer, a new remediated digital asset that complies with regulatory requirements.

12. The system of claim 11, wherein the computer-readable storage device stores additional instructions which, when executed by the processor, causes the processor to perform operations further comprising:
providing the new remediated digital asset to an exchange.

13. The system of claim 11, wherein the computer-readable storage device stores additional instructions which, when executed by the processor, causes the processor to perform operations further comprising:
recording in the new remediated digital asset an original purchase price of the unregulated digital asset by the buyer for long-term capital gains treatment.

14. The system of claim 11, wherein extinguishing the unregulated digital asset and issuing the new remediated digital asset are recorded on a blockchain network.

15. The system of claim 11, wherein the computer-readable storage device stores additional instructions which, when executed by the processor, causes the processor to perform operations further comprising:
transmitting a notice to the buyer, based on the confirmation, providing information to the buyer regarding the remedial process.

16. The system of claim 11, wherein parameters stored within the nonregulated digital asset are carried over in the remedial process to the new remediated digital asset.

17. The system of claim 16, wherein the parameters relate to one or more of an accredited status of the buyer, data associated with officers of the issuer, data related to timing of authorizations to sell, and data related to regulatory requirements.

18. The system of claim 11, wherein a timing associated with a sale of the new remediated digital asset is defined by when the buyer purchased the unregulated digital asset.

19. The system of claim 11, wherein a timing associated with a sale of the new remediated digital asset is defined by the issuing of the new remediated digital asset.

20. The system of claim 11, wherein issuing, to the buyer, the new remediated digital asset that complies with regulatory requirements further comprises forking an original blockchain recording the unregulated digital asset, to create a new blockchain for recording the new remediated digital asset.
